(19) United States
(12) Patent Application Publication
(10) Pub. No.: US 2011/0016472 A1
(43) Pub. Date: Jan. 20, 2011

(54) IMAGE PROCESSING APPARATUS, IMAGE PROCESSING METHOD, AND PROGRAM

(76) Inventor: YUUSUKE KOBAYASHI, Tokyo (JP)

Correspondence Address: Mr. Jackson Chen, 6535 N. STATE HWY 161, IRVING, TX, 75039, US

(21) Appl. No.: 12/832,442

(22) Filed: Jul. 8, 2010

(30) Foreign Application Priority Data
Jul. 17, 2009 (JP) 2009-169458

(51) Int. Cl. G06F 9/50; G06F 9/46

(52) U.S. Cl. 718/104; 718/102

(57) ABSTRACT

A job generation unit generates, from a source program, a job to be executed by any of a plurality of processing resources. The job generation unit calculates job characteristic information that allows estimation of an index value capable of indicating the amount of heat generated in the processing resources due to execution of the job, and appends the job characteristic information to the job. This makes it possible to estimate a temperature rise in a processing resource to which the job is allocated, by using a method that facilitates implementation in a system in which a scheduler allocates a job to a plurality of processing resources.

### INCORPORATION BY REFERENCE

This application is based upon and claims the benefit of priority from Japanese Patent application No. 2009-169458, filed on Jul. 17, 2007, the disclosure of which is incorporated herein in its entirety by reference.

### BACKGROUND OF THE INVENTION

1. Field of the Invention

The present invention relates to an information processing technique, and more particularly, to a technique for allocating a job to a plurality of processing resources.

2. Description of Related Art

In recent years, the processing capability of computational resources such as CPU chips has been improved and the amount of heat generated in LSIs for use as computational resources has been increasing. A temperature rise due to the heat generation causes a problem of shortening the lifetime of the LSI itself and of electronic components provided in the vicinity of the LSI.

In a supercomputer or a multiprocessor including a plurality of processing resources, for example, attempts have been made to solve this problem by contriving a method of allocating a job to the plurality of processing resources (which is also referred to as “scheduling”).

Japanese Unexamined Patent Application Publication No. 08-16531, for example, discloses a technique for a parallel computer system composed of a plurality of PEs (processor elements) in which the temperature of each PE is monitored by a corresponding temperature sensor and a new job is allocated to the PE having the lowest temperature. According to this technique, it is considered that the temperature rise in the plurality of PEs can be made uniform. Meanwhile, the recent parallel computer systems include a plurality of PEs integrated on a small chip, which makes it difficult to arrange the temperature sensors for detecting the temperatures of the PEs.

Further, Japanese Unexamined Patent Application Publication No. 2004-240669 discloses a technique in which a scheduler estimates a temperature rise in each PE which is associated with job processing, and allocates a job based on estimation results. According to this technique, it is expected to solve the problem which is inherent in the technique disclosed in Japanese Unexamined Patent Application Publication No. 08-16531 and which occurs due to the fact that temperature sensors are required.

The technique disclosed in Japanese Unexamined Patent Application Publication No. 2004-240669 is based on the premise that a temperature rise in the PEs can be estimated by a scheduler. However, Japanese Unexamined Patent Application Publication No 2004-240669 fails to disclose a specific method of estimating the temperature rise. Therefore, even a person skilled in the art finds it difficult to know how to estimate the temperature rise, based on the description of the related art.

Japanese Unexamined Patent Application Publication No. 2004-240669, for example, discloses a mode in which a scheduler periodically estimates a temperature rise based on a timer. In this mode, there is a possibility that the scheduler estimates a temperature rise in the PE that processes the job during processing of a previously allocated job. Generally, a typical scheduler can detect the current remaining amount of load of each PE. However, in the technique of estimating a temperature rise at a given time based only on the remaining amount of load in a structure with no sensor, it is difficult to implement the scheduler, unless a specific method of estimating the temperature rise based on the remaining amount of load is provided.

### SUMMARY

An exemplary aspect of the present invention is an information processing apparatus including a job generation unit that generates, from a source program, a job to be executed by any of a plurality of processing resources. The job generation unit calculates, upon generation of the job, job characteristic information that allows estimation of an index value capable of indicating an amount of heat generated in the processing resources due to execution of the job, and appends the job characteristic information to the job.

Even when the information processing apparatus according to an exemplary aspect of the invention is replaced with a system, a method, or a program for causing a computer to execute processing of the information processing apparatus, it can still be effective as one aspect of the present invention.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF THE DRAWINGS

FIG. 1 is a schematic diagram showing a job generation unit to illustrate the principle of the technique according to the present invention;

FIG. 2 is a diagram showing a computer system according to an exemplary embodiment of the present invention;

FIG. 3 is a flowchart showing a flow of a process executed by a compiler in the computer system shown in FIG. 2; and

FIG. 4 is a diagram illustrating a process in which a scheduler in the computer system shown in FIG. 2 estimates a variation in temperature of a processor.

### EXEMPLARY EMBODIMENT

The elements illustrated in the drawings as functional blocks for performing various processes can be implemented hardwarewise by a processor, a memory, and other circuits, and softwarewise by a program recorded or loaded into a memory or the like. Accordingly, it is to be understood by those skilled in the art that these functional blocks can be implemented in various forms including, but not limited to, hardware alone, software alone, and a combination of hardware and software. Additionally, for ease of understanding, only necessary elements are illustrated in the drawings to explain the technique of the present invention.

Further, the program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

Prior to description of exemplary embodiments of the present invention, the principle of the technique according to the present invention will now be described.

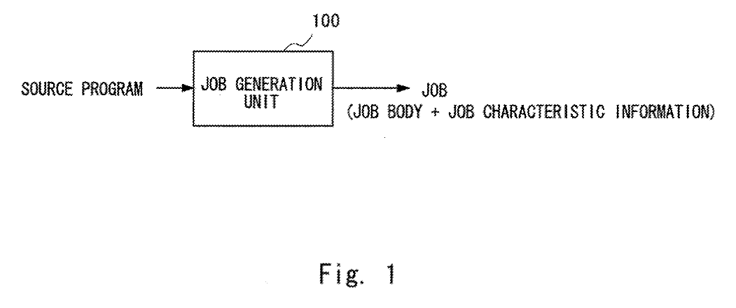

FIG. 1 is a schematic diagram showing a job generation unit 100 according to the technique of the present invention. The job generation unit 100 generates, from a source program, a job to be processed by any of a plurality of processing resources. Upon generation of the job, the job generation unit 100 calculates job characteristic information that allows estimation of an index value capable of indicating the amount of heat generated in the processing resources due to the execution of the job. Further, the job generation unit 100 appends the job characteristic information to the job. As shown in FIG. 1, the job output from the job generation unit 100 includes a job body and job characteristic information.

According to the technique of the present invention, upon generation of a job from a source program, i.e., upon compiling, the job characteristic information that allows estimation of the index value is calculated and then appended to the job. When the job is thereafter allocated to the plurality of processing resources, a scheduler can estimate the index value based on the job characteristic information. Since the index value is capable of indicating the amount of heat generated in the processing resources due to the execution of the job, a temperature rise or the like in the processing resources due to the execution of the job can also be calculated.

Furthermore, the job characteristic information is acquired when the job is generated from the source program, which facilitates implementation.

On the basis of the above-mentioned principle, the exemplary embodiments of the present invention will be described below.

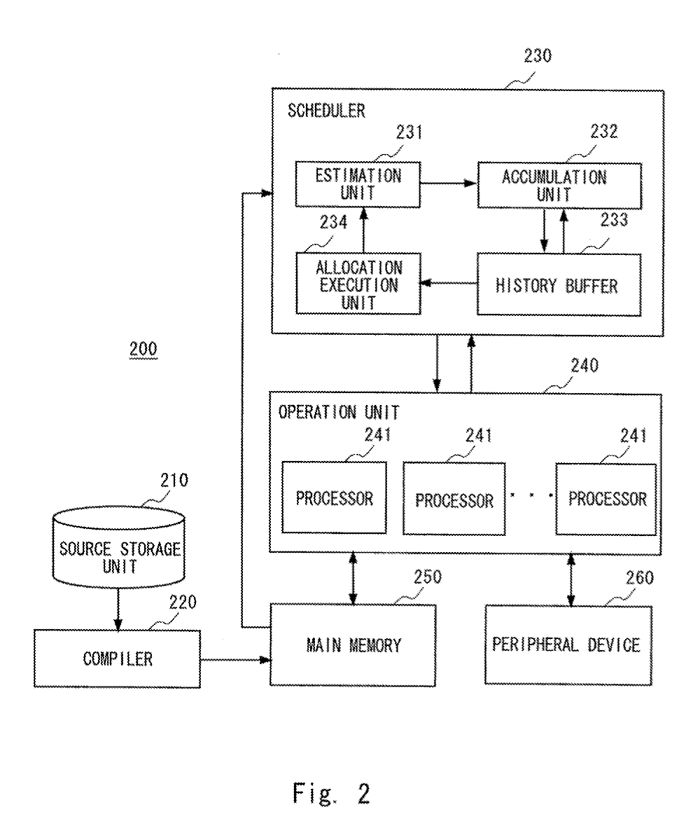

FIG. 2 shows a computer system 200 according to an exemplary embodiment of the present invention. The computer system 200 includes a source storage unit 210 for storing a source program, a compiler 220, a scheduler 230, an operation unit 240, a main storage 250, and a peripheral device 260.

The main storage 250 is also called a main memory. The peripheral device 260 is, for example, a hard disk.

The compiler 220 generates a job from a source program stored in the source storage unit 210 and stores the generated job in the main storage 250. The job is processed by any of a plurality of processors 241 provided in the operation unit 240. In this exemplary embodiment, upon generation of the job, the compiler 220 calculates job characteristic information necessary for estimating an index value capable of indicating the amount of heat generated in the processors due to the execution of the job, and then appends the job characteristic information to the job. The index value and the job characteristic information will be described in detail later.

The operation unit 240 includes the plurality of processors 241. The processors 241 each include a plurality of computing elements that are adaptable to SIMD (SIMD: Single Instruction Multiple Data) operation and SISD (SISD: Single Instruction Multiple Data) operation.

The scheduler 230 performs processing for allocating the job, which is generated by the compiler 220 and is stored in the main storage 250, to any of the processors 241 of the operation unit 240. The scheduler 230 includes an estimation unit 231, an accumulation unit 232, a history buffer 233, and an allocation execution unit 234.

The allocation execution unit 234 executes allocation of a job to any of the processors 241 of the operation unit 240.

The estimation unit 231 reads out the job characteristic information appended to the job to be allocated, and holds the read job characteristic information. When the processor 241 to which the job is allocated completes execution of the job, the processor 241 estimates an index value capable of indicating the amount of heat generation associated with the processing for the job.

The accumulation unit 232 cumulatively adds the index values for each of the plurality of processors 241 to obtain a cumulative index value, and outputs the cumulative index value to the history buffer 233. Specifically, each time the estimation unit 231 estimates the index value, the accumulation unit 232 obtains a new cumulative index value by adding the index value estimated by the estimation unit 231 to the previous cumulative index value of the processor 241 to which the job is allocated. The previous cumulative index value is stored in the history buffer 233. Based on the new cumulative index value thus obtained, the history buffer 233 is updated.

The history buffer 233 stores the cumulative index value calculated by the accumulation unit 232 for each of the processors 241.

Upon allocation of the current job, the allocation execution unit 234 refers to the history buffer 233, and allocates the job to the processor 241 having a minimum cumulative index value. The allocation execution unit 234 notifies the estimation unit 231 of the processor 241 to which the job is allocated.

The processor 241 executes the allocated job. Upon completion of execution of the job, the processor 241 outputs a job end signal to the scheduler 230. Upon receiving the job end signal from any of the processors 241, the allocation execution unit 234 of the scheduler 230 outputs the job end signal to the estimation unit 231.

The amount of heat generated when each processor processes a job will first be described to explain in detail the job characteristic information and index value, which are used in the computer system 200 according to this exemplary embodiment, and the estimation of the index value by the estimation unit 231.

The amount of heat generated in each processor may be determined by the following two factors:
1. The operating rate of the computing elements included in each processor; and
2. The operating rate of an interface through which each processor is connected to the main storage and the peripheral device (the interface is hereinafter simply referred to as “interface”).

### <Regarding the Operating Rate of the Computing Elements>

As more computing elements operate in a processor, the processor generates more heat. This is because when the operating rate of the computing elements becomes higher, power consumption caused by charging/discharging of a capacitor of a transistor increases, leading to an increase in the amount of heat generation.

There is known a technique called DVFS (Dynamic Voltage Frequency Scaling) which has been established recently. This technique involves turning off a clock for a portion that does not operate in a processor, or decreasing an operating frequency of the portion that does not operate in the processor.

Thus, as the operating rate of the computing elements becomes higher, the amount of heat generated in the processor increases for reasons other than charging/discharging of a transistor.

### <Regarding the Operating Rate of the Interface>

In recent years, an interface portion in a processor consumes much power. An interface that operates at high speed is provided in a processor. As the amount of heat generated in the interface increases, power consumption in the interface increases, leading to an increase in the amount of heat generated in the processor. The amount of heat generated in the processor greatly varies depending on the operating rate of the interface.

As disclosed in Non-Patent Document, “M. S. Floyd, S. Ghiasi, T. W. Keller, K. Rajamani, F. L. Rawson, J. C. Rubio, M. S. Ware, “System power management support in the IBM POWER6 microprocessor”, IBM J. Res.& Dev. vol.51, No. 6 (2007), p. 739”, the operating rate of an interface can be controlled by sending an instruction indicating “stop the interface by preventing data from being passed”.

In view of the foregoing, the process in which the compiler 220 calculates the job characteristic information will be described.

In the case of generating a job by compiling a source program, the compiler 220 calculates the job characteristic information in terms of the operating rate of the computing elements in the processor that processes the job and the operating rate of the interface.

### <Regarding the Operating Rate of the Computing Elements>

The operating rate of the computing elements in each processor is determined depending on how the plurality of computing elements in the processor are used in parallel. Examples of parallelization executed when the compiler 220 compiles the source program include:
(1) parallelization at a first granularity: parallelization by a subroutine or a block of a source program; and
(2) parallelization at a second granularity: parallelization at a loop level of the source program.

The parallelization at the first granularity means parallelization at a thread level. In this parallelization, the compiler 220 divides the source program into processing units to be executed by the processor, thereby generating a thread. The thread corresponds to a job.

In the parallelization at the second granularity, loop processing in the source program is analyzed to determine an operation to be allocated to SIMD operators. The number of operations in one thread affects the operating rate of the computing elements in the processor.

In this exemplary embodiment, the compiler 220 counts the total number of operations allocated to the SIMD operators, for each thread. The total number is hereinafter referred to as “SIMD operand ExecSN”.

For the operation that is not allocated to the SIMD operators, i.e., SISD operation, the compiler 220 counts the total number. The total number is hereinafter referred to as “SISD operand ExecN”.

### <Regarding the Operating Rate of the Interface>

The compiler 220 calculates the following two transfer sizes for each job.
(1) Transfer size of a memory access upon execution of a job. The size is hereinafter referred to as “memory access transfer size SiMEM”. Note that the term “memory access” herein described refers to an access to the main storage 250.
(2) Size of data transfer (I/O transfer) with the peripheral device 260 upon execution of a job. The size is hereinafter referred to as “I/O transfer size SiIO”.

Similarly, the compiler 220 generates, upon compiling, an instruction sequence for memory access (e.g., a load instruction and a store instruction) after recognizing the memory access size in the source program. This makes it possible to calculate the memory access transfer size SiMEM.

Similarly, the compiler 220 generates, upon compiling, an instruction sequence for I/O transfer (e.g., an I/O read instruction and an I/O write instruction) after recognizing the I/O transfer size in the source program. This makes it possible to calculate the I/O transfer size SiIO.

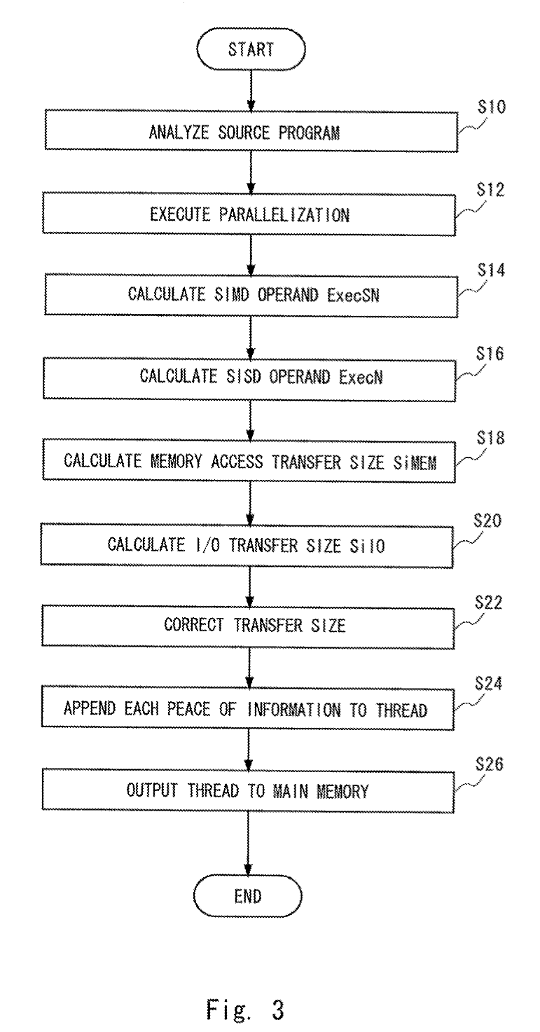

FIG. 3 is a flowchart showing a flow of a process in which the compiler 220 calculates the job characteristic information upon compiling. Upon compiling, the compiler 220 first performs analysis such as lexical analysis or syntax analysis on the source program (S10). Then, the compiler 220 performs parallelization at the first granularity and parallelization at the second granularity based on analysis results obtained in step S10, thereby generating a thread (S12). The compiler 220 calculates the SIMD operand ExecSN for each thread generated in step S10 (S14). Note that the SIMD operand ExecSN represents not the number of instructions but the total number of operations allocated to the SIMD operators.

Further, the compiler 220 calculates, for each thread, the SISD operand ExecN, which is the number of operations that are not allocated to the SIMD operators, the memory access transfer size SiMEM, and the I/O transfer size SiIO (S16, S18, S20).

The compiler 220 corrects the transfer sizes in such a manner that the memory access transfer size SiMEM calculated in step S18 and the I/O transfer size SiIO calculated in step S20 are respectively multiplied by coefficients that are determined depending on the corresponding architecture (S22). Note that the term “architecture” herein described refers to components of a computer system, such as a processor, memory, or I/O. The coefficients may be determined by actually measuring the amount of heat generation after executing a job for measuring an index value on the computer system. Alternatively, the coefficients may be empirically determined depending on the specifications of the components of the computer system.

The compiler 220 appends the SIMD operand ExecSN, the SISD operand ExecN, the corrected memory access transfer size SiMEM, and the corrected I/O transfer size SiIO, which are obtained as described above, to the thread as the job characteristic information, and outputs the thread thus obtained to the main storage 250 (S24, S26).

Next, a description is given of a process in which the estimation unit 231 provided in the scheduler 230 estimates the index value capable of indicating the amount of heat generation associated with the processing for the job executed by the processor 241 to which the job is allocated.

In this exemplary embodiment, the estimation unit 231 uses, as the index value, a variation in an LSI junction temperature Tj (i.e., temperature of a channel portion of a transistor in an LSI) of the processor. In the following description, the variation is represented by “ΔTj/ΔS”. Here, S represents a period of time in which the job is executed (hereinafter referred to as “execution period”). “ΔTj/ΔS” represents a variation of the junction temperature Tj during the period of time S. The symbol “ΔX/ΔS” represents a variation of a variable X during the period of time S.

Upon calculation of ΔTj/ΔS, the estimation unit 231 first reads out the job characteristic information appended to the job, and calculates power consumption P in the processor for processing the job, according to Expression (1).

P=α×ExecSN+β×ExecN+γ×SiMEM+δ×SiIO (1)

In Expression (1), α, β, γ, and δ are coefficients determined depending on the specifications of the processor, and are preset in the estimation unit 231. The amount of heat generation varies depending on the specifications of the processor, even if the same job is processed. Thus, the amount of heat generation or a temperature rise in the processor can be accurately calculated by correcting the job characteristic information using these coefficients.

The scheduler 230 performs the correction because the compiler 220 does not conform to the specifications of the processor in the system. This is due to the fact that compilers are not individually designed for each system in a typical computer system.

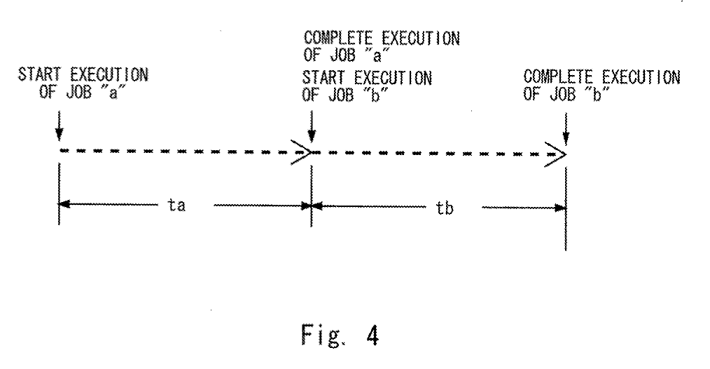

Referring to FIG. 4, a description is given of a process in which the variation ΔTj/ΔS of the LSI is calculated when the processor executes a job “a” and then executes a job “b”. A period of time in which the job “a” is executed is represented by “ΔSa”, and a period of time in which the job “b” is executed is represented by “ΔSb”.

The junction temperature Tj of the LSI can be expressed by Expression (2).

Tj[° C.]=θ(° C./W)×P(W)+Ta(° C.) (2)

In Expression (2), θ represents a heat resistance value that is statically determined if the implementation of the LSI is determined. Ta represents an ambient temperature which is statically determined if the installation location and cooling capability are determined. P represents power consumption in the processor upon generation of a job. In this exemplary embodiment, the estimation unit 231 calculates the power consumption P based on the job characteristic information according to Expression (1).

When the job “b” is subsequently executed after the execution of the job “a” is completed, the variation ΔTj/ΔS from the start of execution of the job “b” to the completion of the execution can be obtained using Expression (3) which is derived from Expression (2).

ΔTj/ΔS=P×Δθ/ΔS+θ×ΔP/ΔS+ΔTa/ΔS (3)

Because the heat resistance value θ and the ambient temperature Ta are constant, Expression (3) can be converted into Expression (4).

ΔTj/ΔS=θ×ΔP/ΔS (4)

Further, when ΔS is small, “ΔP/ΔS” can be approximated to “Pb−Pa”/tb. By this approximation, Expression (5) can be obtained from Expression (4).

ΔTj/ΔS=(Pb−Pa)/tb (5)

Here, Pa represents power consumption corresponding to the job “a” and Pb represents power consumption corresponding to the job “b”.

When Expression (1) is substituted into Expression (5), Expression (6) can be obtained.

ΔTj/ΔS=(ExecSNb−ExecSNa)×θ×(α+β+γ+δ)/tb (6)

As shown above, when the processor executes a program “b”, a temperature variation during the execution period can be calculated using Expression (6).

In this exemplary embodiment, when a job is allocated and the processor 241 to which the job is allocated completes processing for the job, the estimation unit 231 calculates the variation ΔTj/ΔS at the junction temperature Tj of the processor 241 according to Expression (6).

The accumulation unit 232 cumulatively adds ΔTj/ΔS, which is calculated by the estimation unit 231, for the processor, to thereby obtain a cumulative index value. Further, the accumulation unit 232 stores the cumulative index value in the history buffer 233.

Upon allocation of the job, the allocation execution unit 234 refers to the cumulative index value for each processor, which is stored in the history buffer 233, and allocates the job to the processor having a minimum cumulative index value.

Thus, in this exemplary embodiment, upon compiling a job, the job characteristic information is calculated and appended to the job. This enables the scheduler to estimate the amount of heat, which is generated in the processing resource due to the execution of the job, based on the appended job characteristic information. Moreover, the job characteristic information is acquired when the job is generated, which facilitates the implementation.

As described above, Japanese Unexamined Patent Application Publication No. 2004-240669 discloses that a temperature rise is periodically estimated based on a timer. In this case, there is a possibility that the scheduler estimates a temperature rise in the PE that processes the job during processing of a previously allocated job. Considering that a temperature rise should be estimated to facilitate the allocation of a job, it is unclear whether the method of periodically estimating a temperature rise as disclosed in Japanese Unexamined Patent Application Publication No. 2004-240669 is effective in using estimation results for the allocation of a subsequent job, for example.

Meanwhile, in this exemplary embodiment, a temperature rise until the execution of a job is completed is estimated. Therefore, the estimation results can be reliably utilized for the allocation of the job.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

For example, although the estimation unit 231 and the accumulation unit 232 are provided as separate components in the above exemplary embodiment, the functions of the estimation unit 231 and the accumulation unit 232 may be implemented by one component.

Moreover, although the job end signal output from the processor 241 is transferred to the estimation unit 231 by the allocation execution unit 234 in the above exemplary embodiment, the job end signal may be directly output to the estimation unit 231.

What is claimed is:

1. An information processing apparatus comprising a job generation unit that generates, from a source program, a job to be executed by any of a plurality of processing resources,
wherein, upon generation of the job, the job generation unit calculates job characteristic information that allows estimation of an index value capable of indicating an amount of heat generated in the processing resources due to execution of the job, and appends the job characteristic information to the job.

2. The information processing apparatus according to claim 1, wherein the job characteristic information includes an operating rate of a computing element in the processing resources upon execution of the job.

3. The information processing apparatus according to claim 1, wherein
the job characteristic information is included in each of the processing resources, and
the job characteristic information includes an operating rate of an interface that connects between the processing resources and an external device which transmits data between the processing resources during execution of the job by the processing resources.

4. The information processing apparatus according to claim 3, wherein the external device comprises a main storage.

5. The information processing apparatus according to claim 4, wherein the external device further comprises a peripheral device other than the main storage.

6. The information processing apparatus according to claim 1, further comprising a scheduler that allocates a job to the plurality of processing resources,
wherein the scheduler comprises:
an estimation unit that estimates the index value corresponding to the job, for a processing resource allocated the job, by using the job characteristic information appended to the job;
an accumulation unit that obtains a cumulative index value for each of the plurality of processing resources, by accumulating the index values obtained by the estimation unit; and
an allocation execution unit that executes allocation of a job based on the cumulative index value of the plurality of processing resources, the cumulative index value being obtained by the accumulation unit.

7. The information processing apparatus according to claim 6, wherein the estimation unit estimates the index value after correcting the job characteristic information appended to the job, based on characteristics of a processing resource allocated the job.

8. The information processing apparatus according to claim 7, wherein the estimation unit corrects the job characteristic information including a plurality of items, for each of the plurality of items.

9. The information processing apparatus according to claim 6, wherein the estimation unit estimates, as the index value, a variation of a transistor junction temperature of the processing resources.

10. An information processing method comprising the step of calculating, upon generating, from a source program, a job to be executed by any of a plurality of processing resources, job characteristic information that allows estimation of an index value capable of indicating an amount of heat generated in the plurality of processing resources due to execution of the job, and appending the job characteristic information to the job.

11. The information processing method according to claim 10, wherein the job characteristic information includes an operating rate of a computing element in the processing resources upon generation of the job.

12. The information processing method according to claim 10, wherein
the job characteristic information is included in each of the processing resources, and
the job characteristic information includes an operating rate of an interface that connects between the processing resources and an external device that transmits data between the processing resources during execution of the job by the processing resources.

13. The information processing method according to claim 12, wherein the external device comprises a main storage.

14. The information processing method according to claim 13, wherein the external device further comprises a peripheral device other than the main storage.

15. The information processing method according to claim 10, further comprising a scheduling step of allocating a job to the plurality of processing resources,
wherein the scheduling step comprises:
an estimation step of estimating the index value corresponding to the job, for a processing resource allocated the job, by using the job characteristic information appended to the job;
an accumulation step of obtaining an cumulative index value by accumulating the index values obtained in the estimation step, for each of the plurality of processing resources; and
an allocation execution step of executing allocation of a job based on the cumulative index value of the plurality of processing resources obtained in the accumulation step.

16. The information processing method according to claim 15, wherein the estimation step includes estimating the index value after correcting the job characteristic information appended to the job, based on characteristics of a processing resource allocated the job.

17. The information processing method according to claim 16, wherein the estimation step includes correcting the job characteristic information including a plurality of items, for each of the plurality of items.

18. The information processing method according to claim 15, wherein the estimation step includes estimating, as the index value, a variation in a transistor junction temperature of the processing resources.

19. A non-transitory computer readable media storing a program for causing a computer to execute processing comprising:
calculating, upon generating, from a source program, a job to be executed by any of a plurality of processing resources, job characteristic information that allows estimation of an index value capable of indicating an amount of heat generated in the plurality of processing resources due to execution of the job; and
appending the job characteristic information to the job.

20. The non-transitory computer readable media according to claim 19, wherein
the program further causes a computer to execute scheduling processing for allocating a job to the plurality of processing resources, and
the scheduling processing comprises:
estimation processing for estimating the index value corresponding to the job, for a processing resource allocated the job, by using the job characteristic information appended to the job;
accumulation processing for obtaining a cumulative index value by accumulating the index values obtained in the estimation processing, for each of the plurality of processing resources; and
allocation execution processing for executing allocation of a job based on the cumulative index value of the plurality of processing resources, the cumulative index value being obtained in the accumulation processing.
